(19) United States
(12) Patent Application Publication
(10) Pub. No.: US 2022/0384068 A1
(43) Pub. Date: Dec. 1, 2022

(54) TRANSMISSION LINE

(71) Applicant: Tsun Yi KO, Taipei City (TW)

(72) Inventor: Tsun Yi KO, Taipei City (TW)

(21) Appl. No.: 17/376,538

(22) Filed: Jul. 15, 2021

(30) Foreign Application Priority Data
May 26, 2021 (TW) 110119074

(51) Int. Cl. H01B 11/06; H01B 7/04; H01B 7/18

(52) U.S. Cl. CPC H01B 11/06; H01B 7/04; H01B 7/18

(57) ABSTRACT

A transmission line includes a conductor for signal transmission. The transmission line also includes a plurality of isolating individuals arranged to cover the conductor as an isolating layer of the transmission line. The isolating layer has at least one air gap.

### CROSS-REFERENCES TO PRIOR APPLICATIONS

The present invention claims priority under 35 U.S.C. § 119 to Taiwan Patent Application No. 110119074 filed on May 26, 2021, which is hereby incorporated by reference in its entirety.

### BACKGROUND OF THE INVENTION

### Field of the Invention

Embodiments of the disclosed invention relate to a transmission line, and more specifically a transmission line with special structure.

### Descriptions of the Related Art

Most traditional transmission lines are produced with a single isolating individual which is, for example, formed by integration on the surface of a conductor in a laminated way as an isolating layer of the transmission line. Under this situation, it is common to improve the isolation ability by increasing the thickness of the isolating layer. However, this way is not suitable for a small-scale transmission line because increasing the thickness of an isolating layer of the small-scale transmission line will also make the outer diameter of the small-scale transmission line increase. In addition, in the case where the outer diameter of a transmission line is limited, the thickness of the conductor of the transmission line must decrease as the thickness of the isolating layer of the transmission line increases, and thus the transmission rate of the transmission line will decrease. In view of this, it is important in the art to devise a better way of improving the isolation ability of a transmission line.

### SUMMARY OF THE INVENTION

To solve at least the aforementioned problems, embodiments of the disclosed invention provide a transmission line. The transmission line includes a conductor for signal transmission and a plurality of isolating individuals arranged to cover the conductor as an isolating layer of the transmission line, with the isolating layer having at least one air gap.

The disclosed isolating layer is not formed by a single isolating individual, but instead formed by a plurality of isolating individuals among which there is at least one air gap. The special structure of the isolating layer can provide better dielectric strength because the dielectric constant of air is one. Therefore, the disclosed isolating layer can provide better isolation ability than a traditional isolating layer as the thickness of the disclosed isolating layer is almost the same as the traditional isolating layer. Alternatively, the disclosed isolating layer can be formed with a smaller thickness than a traditional isolating layer as the isolation ability of the disclosed isolating layer is almost the same as the traditional isolating layer. Thus, the outer diameter of the disclosed transmission line can decrease, which means that the dimension of the disclosed transmission line can decrease, or the thickness of the disclosed conductor can increase, which means that the transmission rate can increase. It should be appreciated that the disclosed transmission line has an edge over high-speed transmission because high-speed transmission is more sensitive to isolation ability.

On the other hand, the isolating layer which is formed by integration on the surface of a conductor of a traditional transmission line ideally isolates the conductor from air; in other words, there is no intentional air gap in the isolating layer of the traditional transmission line. In contrast, at least one air gap of the disclosed isolating layer can introduce air being a good dielectric medium into the disclosed transmission line, and thus the disclosed transmission line achieve higher transmission rate.

This summary is not intended to limit the scope of the claimed invention, but merely outlines the solvable technical problems, the usable technical means, and the achievable technical effects. As combined with the attached drawings and the following description, a person having ordinary skill in the art can further understand the details of a variety of embodiments of the disclosed invention.

### BRIEF DESCRIPTION OF THE DRAWINGS

FIG. 1 illustrates a schematic profile of a transmission line according to some embodiments of the disclosed invention.

FIGS. 2A, FIG. 2B, FIG. 2C and FIG. 2D illustrate cross-sections of different transmission lines according to different embodiments of the disclosed invention.

FIG. 3 illustrates a schematic profile of another transmission line according to some embodiments of the disclosed invention.

### DESCRIPTION OF EMBODIMENTS

The disclosed invention will be described with reference to embodiments thereof hereinafter. However, these embodiments are not intended to limit the disclosed invention to any operations, environment, applications, structures, processes, or steps described in these embodiments. For ease of description, contents unrelated to the embodiments of the disclosed invention or contents that shall be appreciated without particular description are omitted. Dimensions of elements and proportional relationships among individual elements in the attached drawings are only exemplary examples and not intended to limit the scope of the claimed invention. Unless specifically stated, same (or similar) reference numerals may correspond to same (or similar) elements in this disclosure. Unless otherwise specified, the number of each element described below may be one or more while it is implemented.

Unless the context clearly indicates otherwise, singular forms “a” and “an” are intended to comprise the plural forms as well. The terms such as “comprising” and “including” specify the presence of stated features or components, but do not preclude the presence or addition of one or more other features or components. Unless the context clearly indicates otherwise, the term “and/or” includes any and all combinations of one or more of the associated listed items.

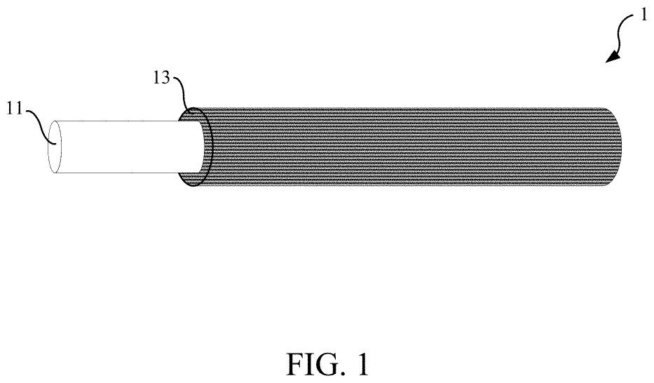

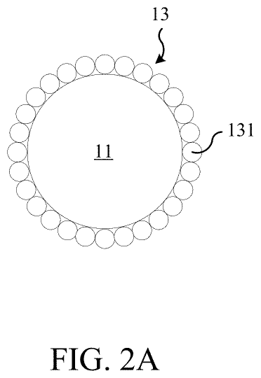

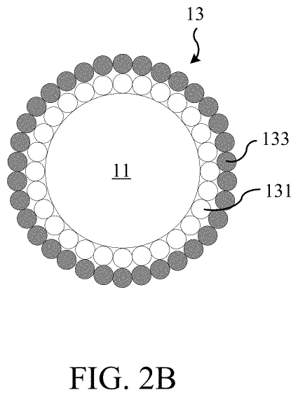

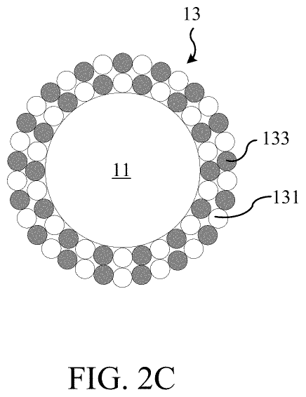

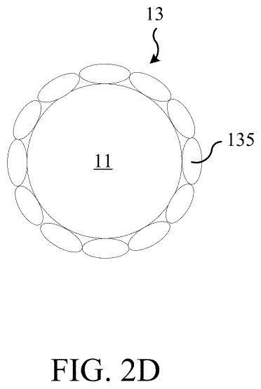

FIG. 1 illustrates a schematic profile of a transmission line according to some embodiments of the disclosed invention. The contents of FIG. 1 are shown as an example for illustrating related embodiments, and are not intended to limit the scope of the claimed invention. FIGS. 2A, FIG. 2B, FIG. 2C and FIG. 2D illustrate cross-sections of different transmission lines according to different embodiments of the disclosed invention. The contents of each of FIGS. 2A, FIG. 2B, FIG. 2C and FIG. 2D are shown as an example for illustrating related embodiments, and are not intended to limit the scope of the claimed invention.

Referring to FIG. 1, a transmission line 1 may comprise a conductor 11. The conductor 11 may be a single wire, or a combination of multiple wires (e.g., stranded conductors). The conductor 11 may be made of one or more metals such as silver, copper, aluminum. The transmission line 1 may also comprise a plurality of isolating individuals arranged to cover the conductor 11 as an isolating layer 13 of the transmission line 1. Each of the plurality of isolating individuals is an isolated thread/strand or an elongated isolation. The shape of a cross-section of the disclosed isolated thread/strand may be substantially a circle. The shape of a cross-section of the disclosed elongated isolation may be a slice-like shape, a lump-like shape, an ellipse, a square, a rectangle, a hexagon, an octagon, etc.

In some embodiments, each of the plurality of isolating individuals is made of an insulating polymeric material. For example, the insulating polymeric material may be chosen from one of FEP, PFA, PE and PTFE or from any combination thereof; however the insulating polymeric material is not limited to these materials.

In some embodiments, a dielectric constant of the isolating layer 13 is between 1.6 and 2.3. Preferably, the dielectric constant of the isolating layer 13 is 1.67, 2.0, 2.03, 2.05, 2.1, or 2.26 with a standard/tolerable deviation.

Referring to FIG. 2A, in some embodiments, the isolating layer 13 of the transmission line 1 may be a single-layer structure. For example, the transmission line 1 may comprise a plurality isolating individuals 131 disposed around the surface of the conductor 11, and each of the plurality isolating individuals 131 is an isolated thread/strand. In addition, the plurality of isolating individuals 131 are not overlaid with each other in the single-layer structure, and there is at least one air gap among the plurality of isolating individuals 131. The number and the dimension of air gaps among the plurality of isolating individuals 131 depends on different needs, and the thickness of each of the plurality of isolating individuals 131 also depends on different needs.

Referring to FIG. 2B, in some embodiments, the isolating layer 13 of the transmission line 1 may be a multiple-layered structure (e.g., a two-layers structure). For example, the transmission line 1 may comprise a plurality isolating individuals 131 disposed around the surface of the conductor 11, and comprise a plurality isolating individuals 133 disposed around the outside of the plurality isolating individuals 131. Each of the plurality isolating individuals 131 and 133 is an isolated thread/strand. In addition, the plurality isolating individuals 131 are not overlaid with each other, and the plurality isolating individuals 133 are not overlaid with each other. There is at least one air gap among the plurality of isolating individuals 131 and 133. The number and the dimension of air gaps among the plurality of isolating individuals 131 and 133 depends on different needs, and the thickness of each of the plurality of isolating individuals 131 and 133 also depends on different needs. In some embodiments, the number of layers of the isolating layer 13 may be more than two.

Referring to FIG. 2C, in some embodiments, the isolating layer 13 of the transmission line 1 may be an interwoven structure or an interlaced structure. For example, the transmission line 1 may comprise a plurality of isolating individuals 131 and 133 which are disposed around the surface of the conductor 11 in an interwoven way or an interlaced way. In addition, each of the plurality isolating individuals 131 and 133 is an isolated thread/strand, and there is at least one air gap among the plurality of isolating individuals 131 and 133. The number and the dimension of air gaps among the plurality of isolating individuals 131 and 133 depends on different needs, and the thickness of each of the plurality of isolating individuals 131 and 133 also depends on different needs.

Referring to FIG. 2D, in some embodiments, the isolating layer 13 of the transmission line 1 may be a single-layer structure. For example, the transmission line 1 may comprise plurality isolating individuals 135 disposed around the surface of the conductor 11, and each of the plurality isolating individuals 135 is an elongated isolation. Here, the shape of a cross-section of each isolating individual 135 is an ellipse. In addition, the plurality of isolating individuals 135 are not overlaid with each other in the single-layer structure, and there is at least one air gap among the plurality of isolating individuals 135. The number and the dimension of air gaps among the plurality of isolating individuals 135 depends on different needs, and the thickness of each of the plurality of isolating individuals 135 also depends on different needs.

In some embodiments, similar to FIG. 2B, the plurality of isolating individuals 135 of FIG. 2D may be arranged such that the isolating layer 13 of the transmission line 1 is a multiple-layered structure in each layer of which the plurality of isolating individuals 135 are not overlaid with each other. In some embodiments, similar to FIG. 2C, the plurality of isolating individuals 135 of FIG. 2D may be arranged such that the isolating layer 13 of the transmission line 1 is a multiple-layered structure in which the plurality of isolating individuals 135 are disposed around the surface of the conductor 11 in an interwoven way or an interlaced way.

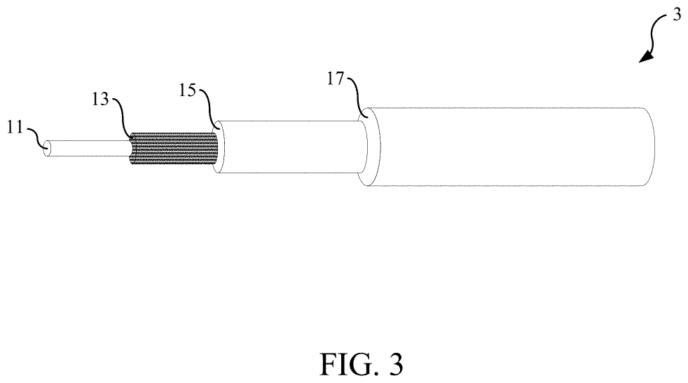

FIG. 3 illustrates a schematic profile of another transmission line according to some embodiments of the disclosed invention. The contents of FIG. 3 are shown as an example for illustrating related embodiments, and are not intended to limit the scope of the claimed invention.

Referring to FIG. 3, a transmission line 3 may comprise a conductor 11 and a plurality of isolating individuals arranged to cover the conductor 11 as an isolating layer 13 of the transmission line 3, which is similar to the transmission line 1 of FIG. 1. Different from the transmission line 1 of FIG. 1, the transmission line 3 of FIG. 3 is a coaxial cable, and thus the transmission line 3 further comprises a shielding layer 15 and a protecting layer 17 in addition to the conductor 11 and the isolating layer 13. The shielding layer 15 may be arranged to cover the isolating layer 13, and the protecting layer 17 may be arranged to cover the shielding layer 15. The shielding layer 15 may be a metallic mesh made of copper or alloy for avoiding outside microwave interference to the conductor 11 and reducing loss of signal transmission. The protecting layer 17 is made of isolating materials and aims to protect the transmission line 3.

The isolating layer 13 of FIG. 3 may be any of the isolating layers 13 of FIGS. 2A, FIG. 2B, FIG. 2C and FIG. 2D or its variations as disclosed above.

The disclosed embodiments are not intended to limit the scope of the claimed invention. Any modifications, replacements, adjustments and/or combinations from/for the disclosed embodiments which a person having ordinary skill in the art can appreciate based on this disclosure are all covered in the disclosed invention, even though they are not fully disclosed in the above descriptions. The claimed invention is defined in the following claims as appended.

1. A transmission line, comprising:
a conductor for signal transmission; and
a plurality of isolating individuals, being disposed around a surface of the conductor and arranged to cover the conductor as an isolating layer of the transmission line;
wherein the isolating layer comprises a multiple-layered structure, and the isolating individuals are not overlaid with each other in each layer of the multiple-layered structure,
wherein each of the isolating individuals is made of an insulating polymeric material chosen from one of FEP, PFA, PE and PTFE or from any combination thereof, and
wherein the isolating layer has at least one air gap within the isolating individuals, and the at least one air gap introduces air into the transmission line.

2. The transmission line of claim 1, wherein each of the isolating individuals is an isolated thread or an elongated isolation.

3. (canceled)

4. (canceled)

5. The transmission line of claim 1, wherein the isolating layer is comprises an interwoven structure or an interlaced structure.

6. (canceled)

7. (canceled)

8. The transmission line of claim 1, wherein a dielectric constant of the isolating layer is between 1.6 and 2.3.

9. The transmission line of claim 8, wherein the dielectric constant of the isolating layer is 1.67, 2.0, 2.03, 2.05, 2.1, or 2.26.

10. The transmission line of claim 1, wherein the transmission line is a coaxial cable, and the transmission line further comprises:
a shielding layer, being arranged to cover the isolating layer; and
a protecting layer, being arranged to cover the shielding layer.
